(19) United States
(12) Patent Application Publication
(10) Pub. No.: US 2003/0149644 A1
(43) Pub. Date: Aug. 7, 2003

(54) Method, system, and apparatus for delivering product

(75) Inventors: Frederick John Stingel III, Asheville, NC (US); Jeffrey W. Stingel, Asheville, NC (US); James N. Smith, Raleigh, NC (US); Angela I. Robertson, Arden, NC (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: Vertique, Inc., Arden, NC

(21) Appl. No.: 10/272,720

(22) Filed: Oct. 17, 2002

Related U.S. Application Data
(60) Provisional application No. 60/354,881, filed on Feb. 5, 2002.

(51) Int. Cl. G06F 17/60

(52) U.S. Cl. 705/28

(57) ABSTRACT

A method of providing products to customers can include identifying order attributes from received orders for cases and identifying case attributes from inventory management data for cases specified in the orders. Cases can be associated with a pallet using the order attributes and the case attributes. For each case associated with the pallet, the case can be assigned a location within the pallet.

### CROSS REFERENCE TO RELATED APPLICATIONS

This patent application claims the priority of U.S. Provisional Patent Application Serial No. 60/354,881 filed Feb. 5, 2002.

### BACKGROUND OF THE INVENTION

1. Technical Field

This invention relates to material handling systems, and more particularly, to organizing cases of products for delivery to customers.

2. Description of the Related Art

Material handling systems can be used in a wide variety of environments to receive, store, and load cases of goods for delivery to customers. Generally, conventional material handling systems can process received customer orders to determine pallet configurations based upon the received orders. The resulting data then can be used to direct material handling machinery to build pallets.

Despite the advantages provided by conventional material handling systems, such systems do have disadvantages. One disadvantage is that conventional material handling systems build pallets having only full layers. For example, a full pallet layer can approximate the length and width of a pallet base within a predetermined tolerance, thereby forming an essentially square layer which approximates the perimeter of the pallet base. Customer orders must specify enough product so that one or more full pallet layers can be built in fulfillment of the customer order. Otherwise, the material handling system cannot build the pallet.

In consequence, customers sometimes order more product than is needed simply to complete a layer of a pallet. Alternatively, the MH system itself can include extra cases of product within pallets, referred to as “bump” cases, to complete individual pallet layers. Although the extra cases typically are sold to customers when delivered, at the time the pallet is built and when the delivery truck leaves the distribution center, the bump cases were not ordered by any customer. The distribution center often assumes the risk of loss relating to the bump cases.

Conventional material handling systems also are limited in the manner in which cases can be configured and placed on pallets. Without an ability to strategically place cases on pallets which can account for customer delivery concerns, conventional material handling systems often pose more of a hindrance than a help with respect to providing cases to customers in a fast and efficient manner. As a result, a delivery person's access to particular cases on a pallet can be limited. The delivery person may be forced to remove cases from a pallet in order to access other cases for selected delivery stops.

Conventional material handling systems also lack the ability to facilitate the delivery of customer orders by accounting for differences in the bay configurations of delivery vehicles and differences in delivery route types. To date, the assignment of a delivery vehicle to a particular delivery route has been a manual process wherein an operator decides which pallets to load into bays of particular delivery vehicles. The pairing of delivery vehicles to specific delivery routes also has been determined manually.

Another disadvantage of conventional material handling systems is that such systems often lack the ability to interact with inventory management systems in way which provides system operators with adequate feedback when cases are unavailable to fulfill customer orders. Consequently, the material handling system may be unaware of whether the inventory necessary to complete a customer order is presently in stock. In consequence, conventional material handling systems may configure customer orders automatically without the unavailable cases and without notifying the system operator, or notifying the system operator after the pallets have been configured without the unavailable cases.

### SUMMARY OF THE INVENTION

The invention disclosed herein provides a method, system, and apparatus for building and delivering pallets to customers. The present invention can be used as a standalone system or in conjunction with presently available automated material handling systems, customer order entry systems, and inventory management systems to build pallets based upon a variety of attributes.

One aspect of the present invention can include a method of providing cases of products to customers. The method can include identifying order attributes from received orders for cases. The order attributes can include, but are not limited to, a customer identifier, quantities of cases ordered, case identifier for cases ordered, and a delivery route identifier. Case attributes can be identified from inventory management data for cases specified in the orders. The case attributes can include, but are not limited to, case dimensions, weights of cases, weight bearing capacity of cases, and quantities of cases available for fulfilling the orders. Cases can be associated with a pallet using the order attributes and the case attributes. For each case associated with the pallet, the case can be assigned a location within the pallet. The pallet can be built using an automated material handling system according to the case-pallet associations and the assigned case locations.

According to one embodiment of the present invention, the case attributes specify case dimensions, which can be identified. A volume of the pallet can be calculated as cases are associated with the pallets according to the case dimensions. The associating step can be discontinued if the pallet volume exceeds a threshold volume. Cases can be placed on the pallet as specified by the case-pallet associations and the assigned case locations using the automated material handling system so as not to exceed the threshold volume.

If the case attributes specify case dimensions, the method can include identifying the case dimensions and calculating a height of the pallet according to the case-pallet associations, the assigned case locations, and the case dimensions. The associating step can be discontinued if the pallet height exceeds a threshold height. The pallet can be built using the automated material handling system. The cases can be placed on the pallet as specified by the case-pallet associations, the assigned case locations, and the case dimensions so as not to exceed the threshold height.

Cases can be assigned to particular locations within the pallet for delivery to customers in first-in-last-out fashion. Using the automated material handling system, cases can be placed on the pallet in particular locations for delivery to customers in first-in-last-out fashion. The associating step and the assigning step can be performed for additional cases and additional pallets. An order for loading the pallet and the additional pallets into a delivery vehicle in first-in-last-out fashion according to an ordering of customers on a delivery route can be determined.

According to another embodiment of the present invention, the case attributes specify weights of the cases. Accordingly, the assigning step can include identifying the weights of the cases for the pallet. Heavier ones of the cases can be assigned to lower locations within the pallet than lighter ones of the cases. Using the automated material handling system, the heavier ones of the cases can be placed on the pallet in a lower location than lighter ones of the cases.

If the case attributes specify weight bearing capacity of the cases, the assigning step can include identifying the weight bearing capacity of the cases for the pallet. Cases with a greater weight bearing capacity can be assigned to a lower layer of the pallet than cases having a smaller weight bearing capacity. Using the automated material handling system, cases with a greater weight bearing capacity can be placed in a lower layer of the pallet than the cases having a smaller weight bearing capacity.

The method further can include accessing a customer profile of a customer for whom the pallet is being configured to determine whether bump cases can be received by the customer. The associating step can include associating bump cases with the pallet according to the customer profile. Another embodiment of the present invention can include providing, to the automated material handling system, pallet configuration data specifying an arrangement of cases for a single pallet, such that the automated material handing system builds the single pallet prior to releasing cases associated with a different pallet.

If cases are to be placed on the pallet by a single case placing system and a multiple case placing system, the method can include calculating a height of cases to be added to the pallet by the multiple case placing system. If the height of the cases exceeds a predetermined height, the method can include determining that the pallet is to be secured prior to adding additional cases with the single case placing system.

One or more delivery routes can be determined for delivering cases to customers according to the order attributes, the case attributes, and known locations of the customers. The pallet can be assigned to a delivery route according to the order attributes associated with the pallet. A delivery vehicle can be assigned to a delivery route according to order attributes, the case attributes, and at least one delivery vehicle attribute. Additionally, a delivery vehicle can be assigned to a delivery route according to delivery route attributes, and the pallet can be assigned to a bay of the delivery vehicle according to at least one delivery vehicle attribute.

If the case attributes specify quantities of cases available for fulfilling the orders, the method can include determining whether sufficient cases are available for fulfilling the orders. If sufficient cases are not available, a determination can be made as to whether additional cases have become available for fulfilling the orders.

Yet another embodiment of the present invention can include assigning each case a location in the pallet such that the pallet is formed of full layers of cases of at least one case type and a top layer of cases of at least one case type. The top layer can be less than a full layer. If the order attributes specify cases for at least two different customers, the assigning step can include assigning at least one case for each of the two different customers to a same layer in the pallet.

Another aspect of the present invention can include a method of providing cases of products to customers wherein an arrangement of cases can be determined for building a pallet using a pallet configuration processor with reference to identified case attributes and order attributes. The arrangement of cases can specify a location for each case within the pallet. Cases can be stored in a case storage system and the cases can be released to a case transport system as specified by the arrangement of cases. The cases can be transported using the case transport system from the case storage system to a palletizing system as specified by the arrangement of cases. At least one pallet can be built using the palletizing system as specified by the arrangement of cases.

The present invention also can include retrieving inventory data specifying cases available for delivery to customers and case dimensions. A pallet can be assigned to a delivery vehicle bay and dimensions for the delivery vehicle bay can be identified. An arrangement of cases can be determined which specifies at least one full layer of at least one case type for the pallet. An available volume can be computed for adding a top layer of cases to the pallet according to the delivery vehicle bay dimensions and the case dimensions for cases within the at least one full layer. An arrangement of cases for a top layer of the pallet can be determined one case at a time such that a volume of the top layer does not exceed the available volume.

The method also can include retrieving inventory data specifying cases available for delivery to customers and case dimensions. A plurality of orders can be retrieved wherein each order specifies at least one case to be delivered to a customer and an associated delivery route. Each customer can be associated with one of the delivery routes. Delivery vehicles can be assigned to the delivery routes according to the cases to be delivered to customers on each of the delivery routes as determined from the orders and the case dimensions. The delivery vehicles can be assigned to delivery routes according to delivery route type. The method further can include disassociating one of the customers from one of the delivery routes and associating the disassociated customer with a different one of the delivery routes.

Another aspect of the present invention can include receiving an order specifying cases to be delivered to a customer and receiving inventory data from an inventory management system. The inventory data can be processed to determine whether sufficient inventory is available to fulfill the customer order. A user can be notified that at least one of the ordered cases is not available. Further, the user can be prompted whether to proceed despite the one or more ordered cases not being available. If the user response is to proceed, at least one pallet can be configured without the unavailable case or cases.

The method also can include receiving at least one order specifying cases to be delivered to a customer and receiving inventory data specifying case dimensions and weights of the cases. An arrangement of cases to be delivered on a pallet can be determined wherein heavier ones of the cases are assigned to locations lower in the pallet than lighter ones of the cases.

Still, the method can include receiving at least one order specifying cases to be delivered to a customer and receiving inventory data specifying case dimensions and weight bearing capacity of the cases. An arrangement of cases to be placed on a pallet can be determined wherein cases capable of bearing more weight than other ones of the cases are assigned to lower locations within the pallet.

Another aspect of the present invention can include a system for organizing cases of products for delivery to customers. The system can include a pallet configuration processor configured to assign cases to locations within at least one pallet according to a type of cases ordered by customers, a number of cases ordered by customers, and dimensions of cases ordered by customers. The system also can include a case storage system configured to store the cases and release the cases according to the assigned locations of cases within the pallets and a palletizing system configured to add selected ones of the cases to a pallet under construction according to the assigned case locations. A case transport system can be included in the system. The case transport system can be configured to deliver the cases from the case storage system to the palletizing system.

The palletizing system further can be configured to build a top layer of cases for the pallet under construction, wherein the top layer of cases is less than a full layer of cases. The pallet configuration processor can be configured to assign cases to locations within a pallet according to weights of individual cases ordered by customers, to assign heavier ones of the cases to lower locations in the pallet than lighter ones of the cases which are assigned to the pallet, and to assign cases having a larger weight bearing capacity than other ones of the cases to lower locations in the same pallet.

The pallet configuration processor also can be configured to calculate a volume of cases to be delivered on a delivery route and to assign a delivery vehicle to the delivery route according to a type of the delivery route and the volume of cases to be delivered on the delivery route. The pallet configuration processor also can assign cases to the pallets according to delivery vehicle bay dimensions. The pallet configuration processor can be communicatively linked to an inventory management system and a customer order entry system.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a distribution center for storing, gathering, and organizing products for shipment to customers through a series of delivery routes according one embodiment of the present invention.

FIG. 2 is a schematic diagram illustrating an exemplary configuration of material handling machinery which can be used with the inventive arrangements disclosed herein.

FIG. 3 is a flow chart illustrating a method of providing cases of products to customers in accordance with the inventive arrangements disclosed herein.

FIG. 4 is a flow chart illustrating a series of sub-steps which can be performed during the method of FIG. 3.

FIG. 5 is a flow chart illustrating a series of sub-steps which can be performed during the method of FIG. 4.

FIG. 6 is a schematic diagram illustrating an exemplary graphical user interface (GUI) which provides a consolidated interface to the inventive arrangements disclosed herein.

FIG. 7 is a schematic diagram illustrating an exemplary GUI for displaying problem SKU numbers and information in accordance with the inventive arrangements disclosed herein.

FIG. 8 is a schematic diagram illustrating an exemplary GUI for searching for inventory items in accordance with the inventive arrangements disclosed herein.

FIG. 9 is a schematic diagram illustrating an exemplary GUI for updating SKU number information in accordance with the inventive arrangements disclosed herein.

FIG. 10 is a schematic diagram illustrating an exemplary GUI for use in administering and maintaining trailers in accordance with the inventive arrangements disclosed herein.

FIG. 11 is schematic diagram illustrating an exemplary GUI for assigning a trailer to a particular delivery route in accordance with the inventive arrangements disclosed herein.

FIG. 12 is a schematic diagram illustrating an exemplary GUI for use in adding a trailer and configuring the trailer for use with different loading bay sizes in accordance with the inventive arrangements disclosed herein.

FIG. 13 is a schematic diagram illustrating an exemplary GUI which can be used to assign trucks to selected delivery routes in accordance with the inventive arrangements disclosed herein.

FIG. 14 is a schematic diagram illustrating an exemplary GUI which can be used for truck processing in accordance with the inventive arrangements disclosed herein.

### DETAILED DESCRIPTION OF THE INVENTION

The invention disclosed herein provides a method and system for building and delivering pallets to customers. The present invention can be used as a standalone system or in conjunction with presently available automated material handling systems, customer order entry systems, and inventory management systems to build pallets based upon a variety of attributes. In particular, the present invention can retrieve customer orders from a customer order entry system and retrieve inventory management data from an inventory management system to determine the availability of cases of products needed to fulfill customer orders. Accordingly, pallet configuration data can be determined based upon a variety of attributes including, but not limited to, product attributes, order attributes, delivery route attributes, and delivery vehicle attributes.

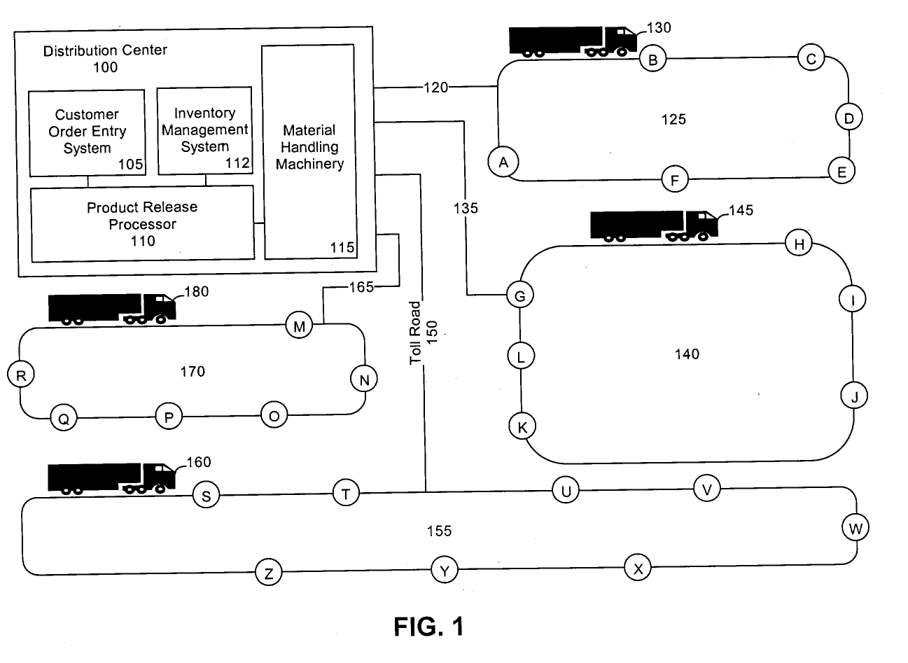

FIG. 1 is a schematic diagram illustrating a distribution center 100 for storing, gathering, and organizing cases of products for shipment to customers through a series of predetermined delivery routes. As shown, the distribution center 100 can include a customer order entry system 105, an inventory management system 112, and a product release processor (PRP) 110. Material handling machinery 115 also can be included.

As shown in FIG. 1, the PRP 110 can be communicatively linked to the customer order entry system 105, the inventory management system 112, and the automated material handling machinery 115 through a computer communications network. Each of the aforementioned systems can include one or more additional data storage units for storing each system's respective data. One or more data storage units which are distributed over the communications network also can be included and shared between the aforementioned systems of the distribution center 100 such that each system can have shared access to distributed data storage units and the data stored therein.

The customer order entry system 105 can include received or entered customer orders for cases of products to be delivered by the distribution center 100. The customer orders can specify order attributes such as the identity of products being ordered, the quantity of each product ordered, a customer identifier, as well as a delivery route identifier. Additionally, the customer order entry system 105 can include customer profile information specifying conventional contact information for the customers in addition to whether each customer has agreed to the inclusion of bump cases in deliveries. It should be appreciated, however, that customer profile information need not be included within the customer order entry system 105. For example, according to another embodiment of the present invention, the customer profiles, and therefore the designation of whether a customer has allowed bump cases, can be stored in the PRP 110 or another distributed data store. The inventory management system 112 can include inventory data specifying product attributes such as the identity and quantity of cases available for fulfilling customer orders. The inventory data further can specify product attributes including the length, width, and height dimensions of cases, the weight of cases, and the load bearing capacity of cases.

The PRP 110 can retrieve customer orders from the customer order entry system 105 as well as retrieve inventory data from the inventory management system 112. The PRP 110 can retrieve an inventory count from the material handling machinery 115 detailing the available cases already loaded and/or stored within that system as well.

Accordingly, the PRP 110 can determine whether sufficient inventory is in stock to fulfill the customer orders. The PRP 110 can track available products as products are used to fulfill customer orders and update the inventory count within the inventory management system 112 as necessary.

Using the inventory data, the PRP 110 can determine pallet configuration data specifying arrangements of cases for placement on one or more pallets. By determining pallet configuration data, the control system 105 provides direction to the automated material handling machinery 115. The pallet configuration data can specify the case release sequence and routing of pallets and cases throughout the material handling machinery 115 when the pallet is physically constructed. More particularly, the pallet configuration data can specify the order in which cases are to be released from various storage locations, which storage locations are to release cases, the routing of cases throughout the material handling system 115, as well as the manner and order in which cases are to be added and placed onto pallets.

Delivery route data can be included in the PRP 110, the customer order entry system 105, and/or within another data storage unit as previously mentioned. Delivery route data can include delivery attributes which can fully specify one or more delivery routes such as delivery routes 125, 140, 155, and 170, including the ordering of stops A-F, G-L, M-R, and S-Z for each delivery route respectively. Delivery route attributes can specify the association between delivery stops, customers, and delivery routes. Delivery route attributes also can specify a type for delivery routes such as bulk, speed, or hand truck delivery. Delivery route attributes can be presented to an operator through one or more graphical user interfaces allowing the operator to select delivery routes and customer stops on the delivery routes.

Through various GUIs of the PRP, an operator can move one or more customers from one delivery route to another. In addition, the operator can change the ordering of customers on each route. This enables the operator to adjust to delivery routes, combine multiple customer stops into a single stop, and make any other alterations to the delivery routes and the order of customer stops on a delivery route according to the amount of product ordered by customers.

For example, bulk and speech type delivery routes both can be used to service customers that routinely order large quantities of cases such that entire pallets typically can be configured for a single customer order. Although both bulk and speed type delivery routes can service large volume customers, the bulk delivery route type can be associated with the largest volume customers. In contrast, hand truck type delivery routes typically service lower volume customers for those situations in which cases for two or more customer orders can be included on a single pallet. Hand truck delivery routes can be serviced by delivery vehicles intended for lower volume orders such as delivery vehicles having side door access to the payload compartment.

The delivery route attributes further can specify distance information, for example the total distance traversed by a delivery vehicle leaving the distribution center 100 in traveling the delivery route, and returning back to the distribution center 100. The delivery route attributes also can specify information relating to the roads not only within the delivery route, but also information concerning any roads such as roads 120, 135, 150, and 165 which must be taken to travel to the delivery routes. For example, the delivery route data can indicate whether any of the roads within a delivery route or leading to a delivery route, such as road 150, are toll roads.

The PRP 110 can include delivery vehicle attributes relating to the particular bay configurations of the delivery vehicles. For example, the PRP 110 can include dimensions (length, width, and height) of the bays within the payload space of each trailer or cargo portion of a delivery vehicle so that pallets can be built according to specific delivery vehicle bays and assigned to those bays of the delivery vehicles. In the case of a flatbed delivery vehicle which has a single large cargo space, the PRP 110 can be programmed with the number of pallets the delivery vehicle can hold. For example, flatbed type delivery vehicles can be said to have the same number of bays as the total number of pallets which the delivery vehicle can hold. Still, the PRP 110 can include any of a variety of different programmable attributes relating to the delivery vehicles and is not limited only to those disclosed herein. For example, the PRP 110 can include an attribute indicating whether the delivery vehicle is equipped with refrigerated payload space.

In any case, the delivery vehicle attributes can specify the dimensions of the payload space of the delivery vehicles and the various bay sizes and configurations of the payload portion of the delivery vehicles. Using the aforementioned attributes, the PRP 110 can automatically determine pallet configuration data to properly build pallets and load delivery vehicles such that deliveries to customers located on one or more predetermined delivery routes can be serviced efficiently. Additionally, the PRP 110 can assign particular delivery vehicles to the delivery routes based upon the known quantity of cases of products ordered by customers on each delivery route, and the volume of products to be delivered on the route.

Delivery vehicles further can be assigned to delivery routes according to delivery vehicle attributes. Delivery vehicle attributes, for example, can indicate whether a delivery vehicle includes a pass enabling non-stop passage through a toll plaza, or whether the delivery vehicle includes an electronic payment system for automatically paying a toll as the delivery vehicle passes through the toll plaza, or any other suitable attribute. Such delivery vehicles can be assigned to delivery routes having an attribute indicating that the delivery route includes one or more toll roads.

The PRP 110 can provide pallet configuration data to the material handling machinery 115. As noted, the pallet configuration data can specify how a pallet is to be built and the release sequence for cases of product to build one or more pallets. The material handling machinery 115 can release cases of product, build pallets, and provide the pallets to a loading dock for loading into delivery vehicles for delivery to customers.

In illustration, if a customer places an order for several cases of a soft drink A, the PRP 110 can retrieve the customer order and any other additional customer orders existing in the customer order entry system 105. Once retrieved, the customer order information can be sorted by delivery route identifier, customer identifier, delivery route type, and for selected delivery route types, the delivery route stop.

From the customer order, the PRP 110 can extract a delivery route identifier corresponding to a particular delivery route on which the customer is located. The PRP 110 further can retrieve inventory data to determine whether sufficient quantities of the soft drink A are available to fulfill customer orders. If so, the pallet configurations can be determined based upon the known quantity of cases of soft drink A ordered, the case dimensions, weight, and load bearing capacity cases of soft drink A, the delivery route specified in the customer order, and the delivery vehicle assigned to the delivery route according to delivery route attributes. Notably, delivery route attributes also can include attributes derived from the customer order itself and the product attributes. For example, delivery route attributes can include the volume of product to be delivered on the delivery route. The delivery vehicle further can be assigned to a delivery route according to delivery vehicle attributes.

Pallets also can be configured and built such that cases capable of supporting increased weight as a result of either the strength of the product itself or the strength of the product case, can be placed in the bottom or lower layers of pallets. Similarly, cases which have a greater weight, for example in comparison with other cases to be included on the same pallet, can be placed on the bottom layer or in a lower layer of the pallet just as lighter cases can be located in the upper layers or top layer of a pallet. Thus, pallets can be built such that each layer can adequately support other layers stacked above. In addition to building pallets according to case weight, weight bearing capacity, and case dimensions, the present invention can configure pallets on a case by case basis so that during delivery, product can be removed from pallets from top to bottom and/or side to side in sequence with the stops on the delivery route.

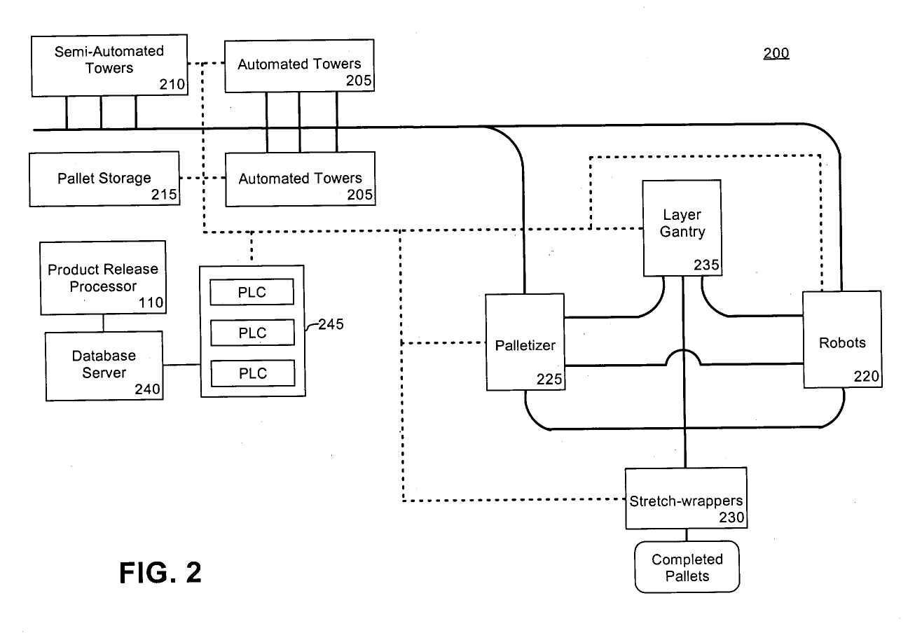

FIG. 2 is a schematic diagram illustrating an exemplary automated material handling system 200 in accordance with the inventive arrangements disclosed herein. The automated material handling system 200 can include various material handling machinery components and/or systems such as automated towers 205, semi-automated towers 210 dispensing cases, a pallet storage area 215, robots 220, a palletizer 225, a stretch-wrapper 230, as well as a full layer gantry 235. Each of the aforementioned components of the automated material handling system 200 can be operated under the control of the PRP 110 and various programmable logic controllers (PLCs) 245.

Both the automated towers 205 and the semi-automated towers 210 can be robotic towers which store product in a vertical fashion. An example of such a robotic tower can include the Vertique (TM) Towers manufactured by Vertique, Inc., located in Arden, N.C. Vertique, Inc. is a division of Jayson Concepts, Inc. Once the towers have been loaded with cases and after the PRP 110 has determined pallet configuration data, the automated towers 205 and the semi-automated towers 210 can release cases as directed by the PLCs 245 under the control of the PRP 110. For example, the PRP 110 can publish the pallet configuration data to a database server 240, as shown, which is communicatively linked to the PLCs 245.

The cases can be released and routed to either the palletizer 225 or the robots 220. The full layer gantry 235 can have access to pallets from which full layers of cases of the same SKU can be extracted and placed on a pallet which is being built. Customer orders which can be fulfilled with pallets having full layers of the same SKU or full layers of different SKU numbers but having common case dimensions can be routed to the palletizer 225 to be included within a pallet layer. The palletizer 225 can add cases of at least two different SKUs to a pallet according to the geometry of cases. For example, two or more smaller cases of products can be placed on a pallet in substitution for a larger case having similar dimensions and/or geometry as the combined two smaller cases.

If a pallet is to include cases which can be placed on a pallet in layers and cases which cannot be placed on the pallet in layers, then cases can be alternately routed to the robots 220, the palletizer 225, and/or the full layer gantry 235. The robots 220 can add cases to pallets in a case by case manner using case attributes such as the dimensions of cases, the geometry of the cases, the weight of cases, and/or the load bearing capacity of cases. Accordingly, the present invention can build pallets having incomplete or non-full layers. Pallets intended on having non-full layers can be routed to the robots 220 which can place individual cases atop of a pallet.

According to another embodiment of the invention, a hand stacking area (not shown) can be included wherein cases can be manually stacked or placed onto pallets in a case by case fashion similar to the manner in which the robot places cases. Cases can be released from case storage systems to the hand stacking area, either directly or after being routed by the case transport system. Similarly, pallets can be routed to the hand stacking area so the cases can be placed.

Accordingly, rather than having only full layers of cases, pallets built using the present invention can include a top layer of one or more cases. Built pallets can be provided to the appropriate loading dock in sequential order for loading on an assigned delivery vehicle. The pallets can be provided to the loading dock in “first in last out” (FILO) fashion for efficiently servicing delivery stops of the delivery routes.

After each pallet is constructed, the completed pallet can be provided to the stretch-wrappers 230 where the pallets can be wrapped with protective plastic or secured using suitable strapping materials. From the stretch-wrappers 230, secured pallets can be loaded onto a delivery vehicle for delivery to customers. Cases of products, complete pallets, and pallets under construction can be routed among the various components of the material handling system 200 using a case and pallet transport system as is known in the art.

Notably, according to another embodiment of the present invention, pallets can be selectively routed to the stretch-wrapper 230 prior to the pallet being completely built. For example, a pallet which is under construction, but has at least a minimum predetermined height, can be routed to the stretch-wrapper 230 for securing those cases which have already been placed on the pallet. This ensures that incomplete pallets are secure while in transit throughout the automated material handling system 200. More particularly, securing pallets in this manner provides a stable base from which additional cases can be added, whether by the full layer gantry 235, the palletizer 225, or the robot 220.

Those skilled in the art, however, will recognize that the layout and configuration of the automated material handling system 200 is disclosed for purposes of illustration. Accordingly, the present invention is not so limited to the particular configuration disclosed herein. Rather, any of a variety of automated material handling system configurations or layouts can be used.

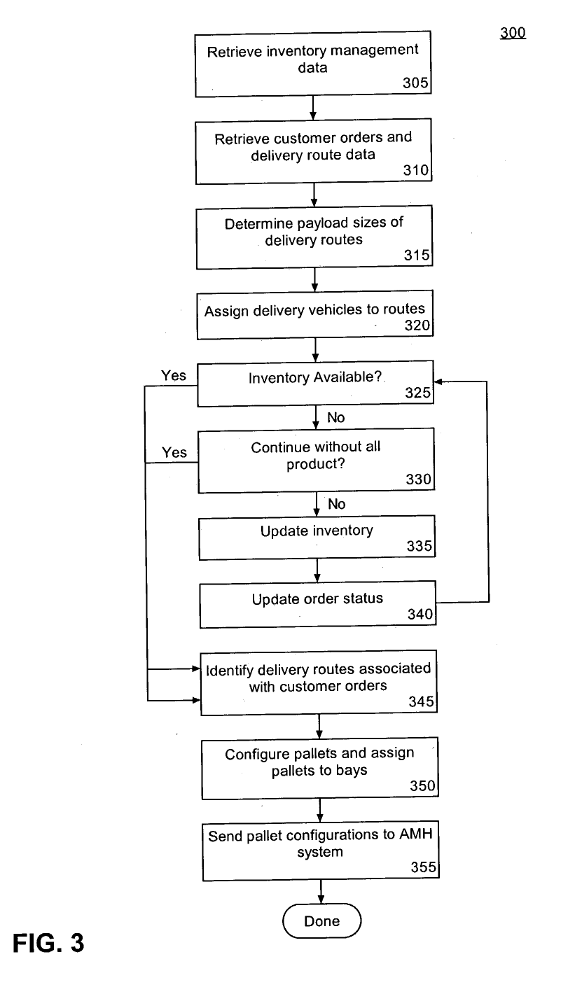

FIG. 3 is a flow chart 300 illustrating a method of providing products to customers in accordance with the inventive arrangements disclosed herein. The method can begin in step 305, where a current inventory count can be retrieved from an inventory management system or data store communicatively linked to an inventory management system. The available inventory within the material handling machinery also can be retrieved, such that the PRP has access to complete inventory data. In step 310, the delivery route data can be retrieved from a data store communicatively linked to the PRP. In step 310, customer orders also can be retrieved. It should be appreciated by those skilled in the art that retrieving can include uploading, downloading, scanning, or parsing.

In step 315, the payload size for each delivery vehicle that is needed to deliver pallets for the received customer orders on each delivery route can be calculated. For example, payload volume can be calculated based upon the known sizes of cases ordered by customers and the total number of cases needed to fulfill customer orders for each respective delivery route.

Accordingly, in step 320, delivery vehicles, and specifically the particular trailer and truck cab needed to haul the calculated payload size, can be assigned to the delivery routes. Thus, particular truck cabs equipped with electronic payment systems can be assigned to delivery routes including toll roads, or to trailers which have been assigned to such delivery routes. Additionally, delivery vehicles having refrigerated payload space can be assigned to delivery routes wherein product to be delivered must be refrigerated. Notably, different truck cabs can be manually re-assigned to trailers to accommodate cases wherein, for example, a truck cab malfunctions and a replacement truck cab is needed to haul a trailer.

It should be appreciated that delivery vehicles can be assigned to delivery routes according to the bay configuration of the payload space of the delivery vehicles. In addition to assigning a trailer to a delivery route according to the known size and quantity of product to be delivered to customers on that route, the trailer can be assigned to a delivery route also based upon the type of the route. Thus, for bulk delivery routes and speed delivery routes, both routes for which entire pallets can be configured for a single customer, a particular style trailer can be used, for example a flatbed style trailer or a trailer having a particular bay configuration suited to the delivery route. For hand truck delivery routes, wherein multiple customer orders can be included on a single pallet, a delivery vehicle having side door access to the payload compartment can be assigned. The examples disclosed herein, however, are included for purposes of illustration only. Accordingly, the examples should not be construed as a limitation on the present invention.

In step 325, a determination can be made as to whether sufficient inventory is available to fulfill each of the received customer orders retrieved in step 310. If sufficient inventory exists, the method can continue to step 345. If not, however, the method can proceed to step 330. In step 330, the PRP can present the user with the option of continuing with the determination of pallet configuration data despite particular cases not being available for configuring and building pallets in fulfillment of customer orders. If the user chooses to continue, the method can proceed to step 345 where pallets can be configured without the unavailable cases. Still, the PRP can store customer orders specifying unavailable cases until such time when additional inventory does become available.

If the user chooses not to continue, the method can proceed to step 335 where the user can manually input data relating to the cases. For example, cases of product may not be available either because the product is out of stock or the PRP lacks product attributes such as case dimensions or weight, which are necessary if the cases are to be included within a pallet build. Accordingly, in step 335, a user can input product attributes such as dimension data, product weights, and/or load bearing capacity into the PRP. Additionally, the user can override the inventory count in situations wherein the PRP indicates that an insufficient amount of product or no product is available, but where the user is aware that product is available for fulfilling customer orders. After step 335, the method can continue to step 340.

In step 340, the status of orders which included previously unavailable products can be updated thereby enabling one or more pallets to be configured in fulfillment of the orders. Thus, any products which were out of stock or which had incomplete product attributes specified which were suitably updated in step 335 can be used to fulfill customer orders. After completion of step 340, the method can continue to step 325 and repeat as necessary.

In step 345, the delivery routes associated with each customer order within the customer order data can be identified. Specifically, the delivery route or delivery route identifier can be extracted from each of the customer orders. The delivery route or delivery route identifier can be correlated with associated delivery route data which was retrieved in step 310.

In step 350, the pallet configuration data can be determined in addition to the loading bay assignments for individual pallets. Thus, the loading sequence for loading the pallets onto the delivery vehicles also can be determined. For example, based upon the customer orders and known delivery routes to which the customer orders are associated, the pallet configurations can be determined so that product can be loaded and then unloaded efficiently during delivery. For example, product can be loaded in FILO fashion so that products designated for customers positioned at the beginning of a delivery route can be located closest to the loading doors of the delivery vehicle.

Additionally, pallets can be configured according to case dimensions and/or case geometry such that pallets can include entire layers of one SKU, layers of two or more SKUs, entire columns of one product or package type, or various combinations thereof. In this manner, pallets can be configured for efficient delivery of product to customers taking into account the ordering of stop fields specified for each delivery route. Notably, pallets can be configured according to conventional pallet base sizes as well as non-conventional pallet base sizes which may be longer, wider, and/or taller than conventional pallet bases typically provided by product manufacturers. Still, any of a variety of possible pallet sizes can be assigned to a suitable delivery vehicle bay.

Pallets also can be configured based upon height. For example, when configuring full layers of a pallet, the bay height need only be considered. The available volume of the bay can be considered when adding incomplete or non-full layers as the top layer of the pallet under construction. Thus, in addition to configuring pallets of varying widths and lengths, pallets can be configured for full bays or half bays of known heights. After completion of step 350, the method can continue to step 355.

In step 355, pallet configuration data can be provided to the material handling machinery via the PLCs for beginning the pallet building process. In particular, pallet configuration data can specify the order in which cases of product are to be released, where the product is to be routed, and how the pallets are to be built. As mentioned, the pallet configurations can be provided to the material handling machinery on a delivery vehicle by delivery vehicle basis, a pallet by pallet basis, or for one or more entire delivery routes.

The pallet configuration data also can specify pallet builds for multiple runs of a single delivery vehicle. For example, after delivery of a first payload, the delivery vehicle can return to the distribution center to pick up a second payload. The pallet configurations for the second payload can be determined by the PRP at substantially the same time as the first payload. Notably, the PRP enables a user to release one or more delivery vehicles at a time. Thus, pallet configurations can be provided to the material handling machinery for all delivery vehicles (and delivery routes) or for only those delivery vehicles selected by a user.

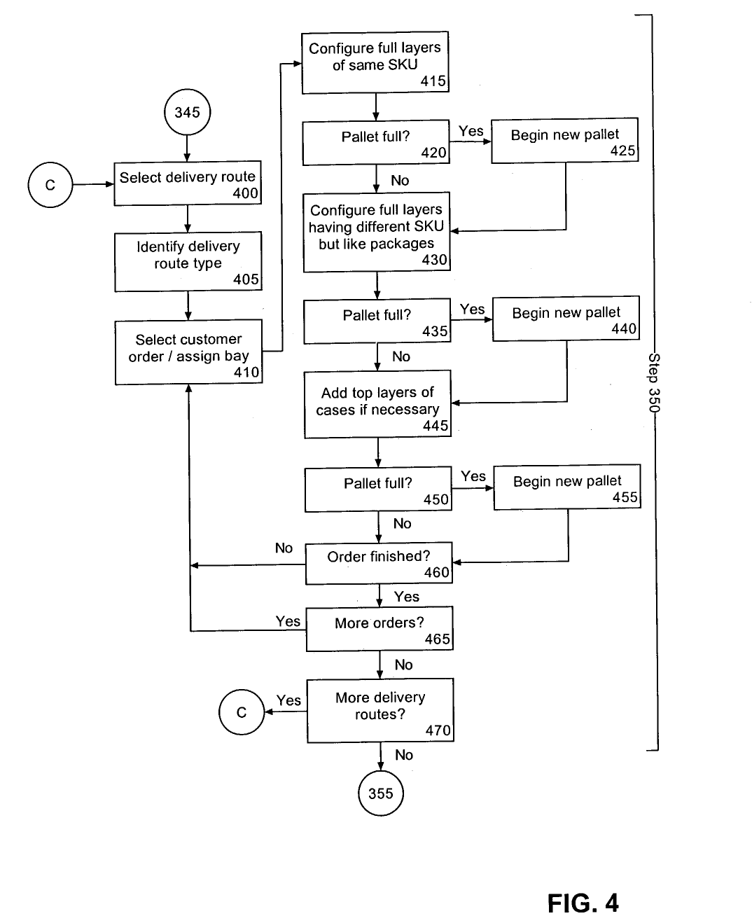

FIG. 4 is a flow chart illustrating a series of sub-steps which can be performed in fulfillment of step 350 of FIG. 3. As shown in FIG. 4, the method can proceed from step 345 to step 400 where a particular delivery route can be selected. In step 405, the delivery route type can be identified. For example, the delivery route can be identified as bulk, speed, or hand truck. It should be appreciated, however, that other delivery route types can be defined based upon any set of delivery route attributes that may be included in the delivery route data which may affect pallet configurations.

In step 410, as delivery vehicles have been assigned to delivery routes, a customer order can be selected and assigned to one or more bays of the delivery vehicle assigned to the current delivery route. For example, the customer orders can be selected on a FILO basis according to customer placement on the delivery route. The particular bay also can be assigned to the customer order based upon the placement of the customer order within the delivery route as well as the bay space and number of pallets needed to contain the cases of product ordered by the customer.

In step 415, if any full layers of the same SKU can be configured for the current pallet under construction and customer order, those layers can be configured. In step 420, a determination can be made as to whether the current pallet being configured is full. The determination can be made with respect to the available volume of the associated delivery bay in addition to any predetermined pallet dimension guidelines or rules. If the pallet is full, the method can proceed to step 425 to begin a new pallet. If not, the method can continue to step 430 to continue configuring pallet layers for the current pallet. 7

In step 430, if any full layers of different SKUs can be configured according to the customer order, those layers are configured. Also, full layers of different cases having geometries which can be suitably combined to form a full and stable pallet layer can be configured. In step 435, a determination again can be made as to whether the pallet is full. If so, the method can proceed to step 440 to begin a new pallet. If not, the method can proceed to step 445, where one or more additional top layers of cases can be added to the pallet. The top layers, however, need not be full layers. Rather, the top layers can include one or more cases such that the perimeter of the each layer is substantially less than the perimeter of the base of the pallet or a layer beneath. Also, the perimeter of the top layer or layers need not be substantially aligned to the pallet base shape.

In determining the layers of the pallet under construction in steps 415, 430, and 445, it should be appreciated that the layers can be assigned a relative placement within the pallet based upon attributes other than case dimension. In particular, the layers can be located toward the top or bottom of the pallet based upon the weight of the individual cases included within the layer as well as the load bearing capacity of the individual cases within the layer. Thus, while cases of bottles or cases of cans of paint can be located in a lower layer of a pallet, more fragile and lighter cases such as a case of potato chips can be located in the upper layers or the uppermost layer of the pallet.

In step 450, a determination can be made as to whether the pallet is full. If so, the method can proceed to step 455 to begin a new pallet. If not, the method can continue to step 460. In step 460, if the current customer order is finished, the method can continue to step 465. If not, however, the method can continue to step 410 to continue with the current customer order and repeat as necessary. In step 465, if additional customer orders have yet to be fulfilled for the current delivery route, the method can continue to step 410 where the next customer order can be selected.

Notably, depending upon the delivery route type and the cases ordered, the next customer order can be started where the previous customer order left off. For example, the next customer order can be started on the same pallet as the previous order if that pallet has available space. The next customer order further can be started within the same layer of the current pallet if the layer was incomplete. The next customer order can be started on the current pallet as a non-full top layer. Additionally, the next customer can be started within a non-full top layer such that the non-full top layer can include products from two different customer orders.

Still, a new pallet can be provisioned and configured for the next customer order. For example, customer orders for hand truck delivery routes can be configured continuously such that cases of product for multiple orders can be placed on a single pallet. As mentioned, in addition to loading the pallets onto delivery vehicles in FILO fashion, the pallets themselves can be configured in FILO fashion. For example, products for a first customer of a delivery route can be located in the top layers of a pallet while products for the second customer can be located in the bottom layers of the same pallet. By comparison, bulk and speed delivery route types can be organized such that each pallet includes cases of product for a single customer order. The method, however, should not be limited to the embodiments disclosed herein. As mentioned, users can specify additional delivery route types and accordingly specify the situations in which the PRP should begin a new pallet.

In step 470, a determination can be made as to whether additional delivery routes have yet to be configured. If additional delivery routes have yet to be fulfilled, the method can continue to step 400 through jump circle C. If all of the delivery routes have been configured, the method can continue to step 355 of FIG. 3.

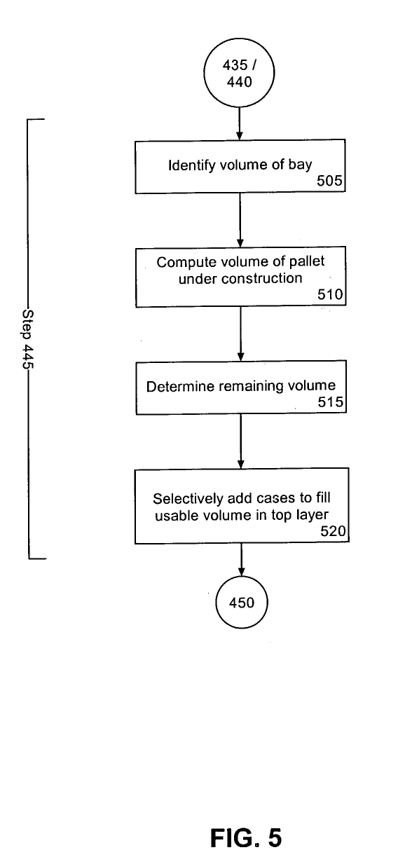

FIG. 5 is a flow chart illustrating a series of sub-steps which can be performed in fulfillment of step 445 of FIG. 4. Accordingly, FIG. 5 depicts the manner in which additional cases can be added in a case by case fashion to form one or more top layers of a pallet under construction. Notably, pallets can be considered to be completed pallets when the PRP labels the pallet as such. Completed pallets need not include a minimum number of layers, products, or the like. Consequently, the top layer need only be the last layer added to the pallet.

The method can continue from step 435 or step 440 of FIG. 4 to step 505 where a reference volume for the currently assigned bay can be determined. The reference volume can be the determined from the bay dimensions which can be included within the system thereby enabling the volume to be calculated. Alternatively, the reference volume can be explicitly programmed with an actual volume or with a predetermined volume which is set according to delivery vehicle type and/or bay type. Still, other attributes regarding the delivery vehicle bay and the pallet under construction can be included in the PRP. For example, the maximum average weight of a pallet which can be accommodated by each delivery vehicle bay can be included thereby allowing the PRP to determine suitable pallet configurations for delivery vehicle bays based not only upon dimensions, but also the overall weight of the pallet under construction.

In step 510, the volume of the pallet under construction can be calculated according to the cases and layers which have already been configured for the pallet as well as the known dimensions of the pallet base. Notably, in addition to calculating the available volume of the delivery vehicle bay, the height of the pallet under construction can be calculated for determining the available height within the bay for additional cases forming a top layer.

In step 515, the available volume of the bay can be calculated based upon the known volume of the delivery vehicle bay and the volume of the pallet under construction. Alternatively, the available volume can be determined by calculating the height of the full layers of the pallet under construction including the height of the pallet base in relation to the known height of the delivery vehicle bay. The height difference can be used to calculate a volume which is available for adding one or more top layers of cases to the pallet. In particular, the height difference can be used in conjunction with the known length and width of the delivery vehicle bay to calculate the available volume.

In one embodiment of the present invention, the calculated available volume of the delivery vehicle bay can be reduced using a predetermined factor between 0 and 1 to ensure that the top layer or layers of cases to be configured and added to the pallet will fit within the available space. Other methods for reducing the available volume, however, can be used such as subtracting a predetermined volume from the available volume. Accordingly, the present invention is not limited to one particular method of reducing the available volume. In any event, the PRP can calculate an available volume that is less than the actual available volume, which can be filled with additional cases of product. The predetermined factor or amount subtracted can be varied according to the delivery vehicle type and delivery vehicle bay configurations.

In step 520, the additional cases of product can be added case by case according to many of the same attributes as previously discussed including product dimension, geometry, and weight.

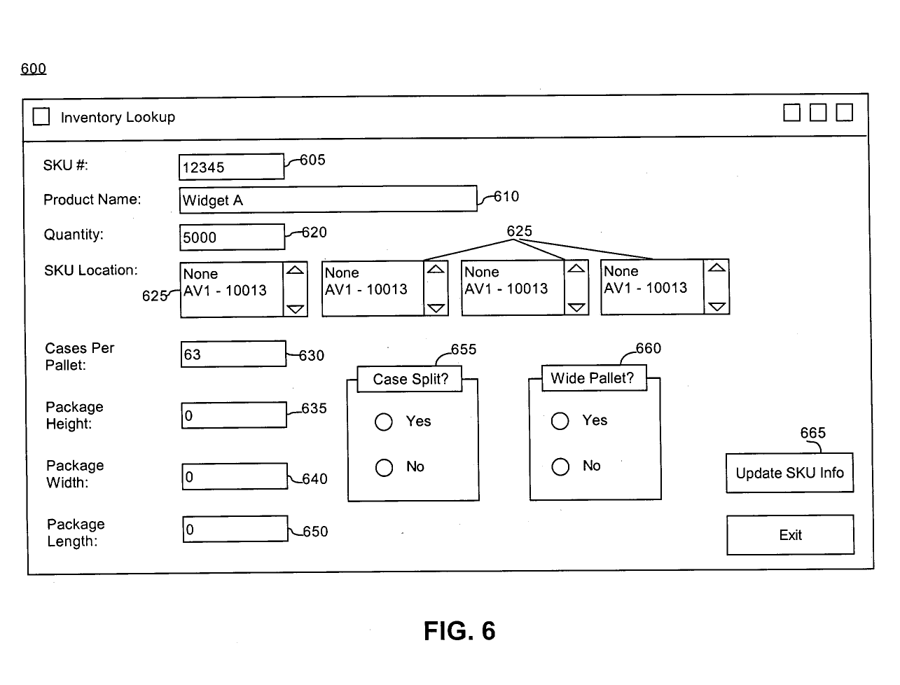

FIG. 6 is a schematic diagram illustrating an exemplary GUI 600 for updating SKU number information. Through GUI 600, a user can input information necessary for the PRP to configure one or more pallet builds. Accordingly, data field 605 can display the selected SKU number or the SKU number of the item selected for updating. Data field 610 can display the product name corresponding to the SKU number displayed in data field 605. Data field 620 can display the quantity of the SKU number in stock based upon the latest downloaded inventory management count, as well as any cases already loaded within the material handling machinery. Display fields 625 can be used to specify one or more locations, for example accessible storage areas and/or shelving systems of the material handling machinery, in which cases of the selected SKU number is stored.

Data fields 630, 635, 640, and 650 can be used to specify packaging specifications such as the number of cases of product which can be included on a pallet, the height of cases of the selected SKU, the width of the selected SKU, and the length of the selected SKU respectively. This information enables the PRP to properly configure pallet builds. In addition, radio buttons 655 enable the user to determine whether a case of the product can be split. A case split refers to a smaller case which occupies approximately one-half of the volume of a single larger case. An example of a case split can include a case of 12 beverage containers or a “12-pack” which can be combined with another 12-pack to approximate the dimensions of a larger case of 24 beverage containers. The smaller “12 pack” cases can be referred to as case splits.

Radio button 660 can be used to specify whether the product packaging can be used with wide pallet configurations. Depending upon the PRP system configuration, the data corresponding to the selected SKU number can be updated or stored within the PRP or the inventory management system responsive to activation of the “Update SKU Info” icon 665.

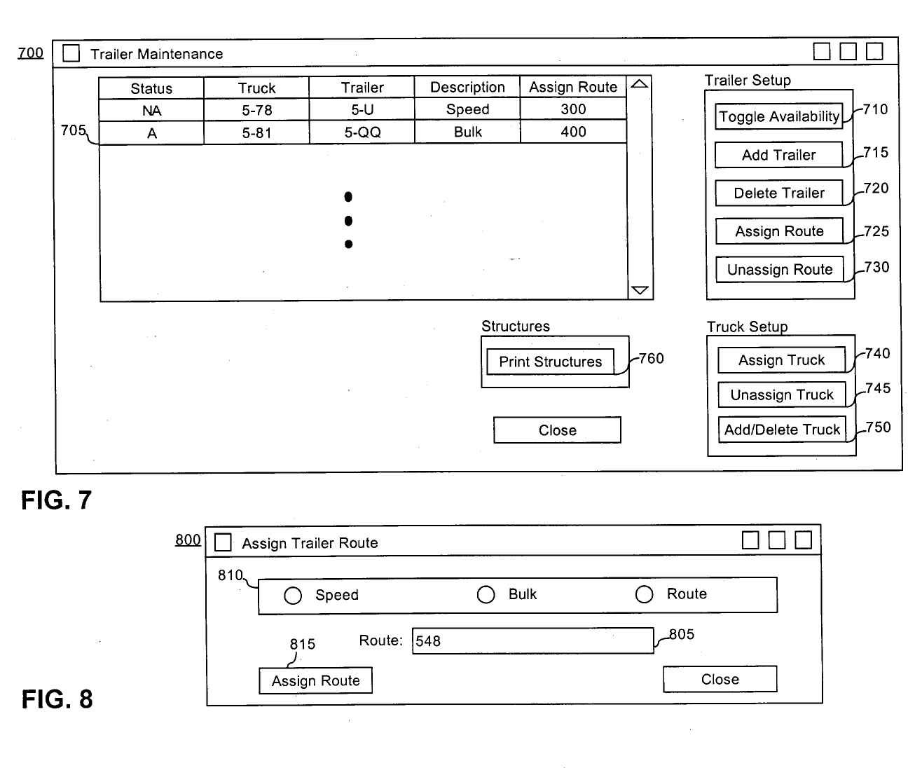

FIG. 7 is a schematic diagram illustrating an exemplary GUI 700 for use with administering and maintaining trailers. As shown, GUI 700 can include a display field 705 which can include a status column indicating whether the trailer is available, a truck column indicating the particular truck to which the trailer has been assigned, a trailer column indicating the trailer identity, a description indicating the type of route to which the present truck and trailer configuration have been assigned, and a route column indicating the particular route to which the truck and trailer configuration has been assigned.

The GUI 700 also can include a series of activatable icons for trailer setup. Activation of the “Toggle Availability” icon 710 can toggle the availability of a highlighted or selected trailer from “available” to “not available”. The “Add Trailer” icon 715 can be used to add a trailer to a particular delivery route and to specify any necessary information pertaining to the trailer. The “Delete Trailer” icon 725 can be used to delete a selected trailer from a delivery route. The “Assign Route” icon 725 can be use to assign a particular route to a designated trailer. The “Unassign Route” icon 730 can be used to unassign or disassociate a trailer from a particular delivery route.

The GUI 700 further can include a truck setup area. The truck setup area can include an “Assign Truck” icon 740 for assigning a truck to a particular delivery route and trailer. An “Unassign Truck” icon 745 can be used to unassign or disassociate a truck from a particular delivery route. The “Add/Delete” icon 750 can be used to add or delete a truck responsive to activation of icon 750. If a truck is selected, the truck can be deleted. If no truck is selected, activation of the “Add/Delete” icon 750 can be used to add a truck. The “Print Structures” icon 760 can be used to initiate a printed report of the trailer maintenance information shown in display window 705.

FIG. 8 is schematic diagram illustrating an exemplary GUI 800 for assigning a trailer to a particular delivery route. For example, after an operator has selected a particular trailer, the GUI 800 allows the operator to manually enter a delivery route number in data field 805, specify the type of delivery route in route type box 810, and assign the delivery route to the selected trailer responsive to activation of the “Assign Route” icon 815.

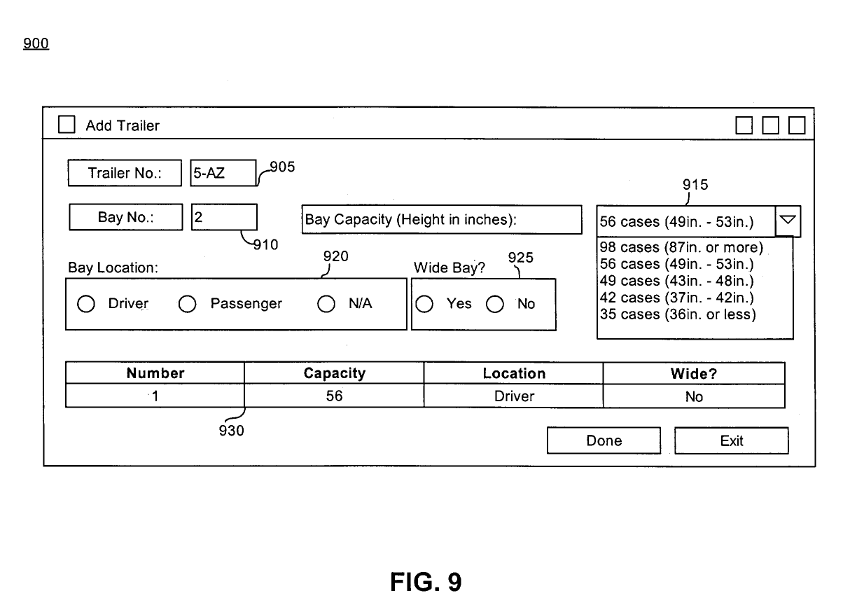

FIG. 9 is a schematic diagram illustrating an exemplary GUI 900 for use in adding a trailer and configuring the trailer for use with different loading bay sizes. The GUI 900 can be displayed responsive to activation of the “Add Trailer” icon 915 of FIG. 7. A user can specify a trailer number in data field 905. Data field 910 can be used to assign a particular loading bay to the trailer specified in data field 905. A user further can specify the capacity of the loading bay in data field 915 using any suitable unit of measure such as cases or inches. An operator also can specify the bay location in area 920 as “driver”, “passenger”, or “N/A”. Finally, an operator can specify whether the loading bay is a wide loading bay type in area 925. As loading bays are added to the system, information specified for each loading bay can be shown in display field 930.

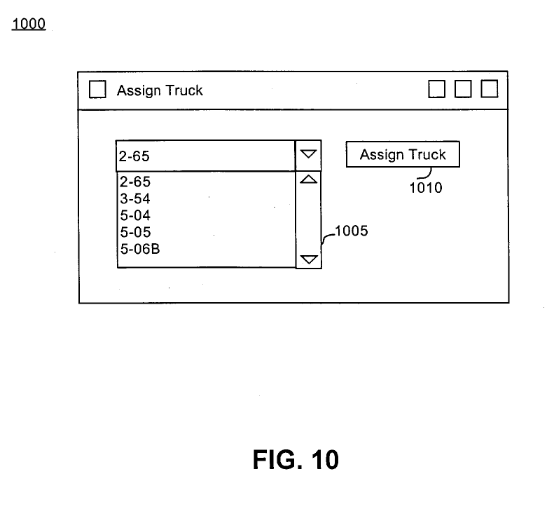

FIG. 10 is a schematic diagram illustrating an exemplary GUI 1000 which can be used to assign trucks to selected delivery routes. The GUI 1000 can be displayed responsive to selection of the “Assign Truck” icon 740 of FIG. 7. Accordingly, a user can select a truck from the drop down style display field 1005 to assign a particular truck to the delivery route. The truck can be assigned to the delivery route responsive to activation of the “Assign Truck” icon 1010.

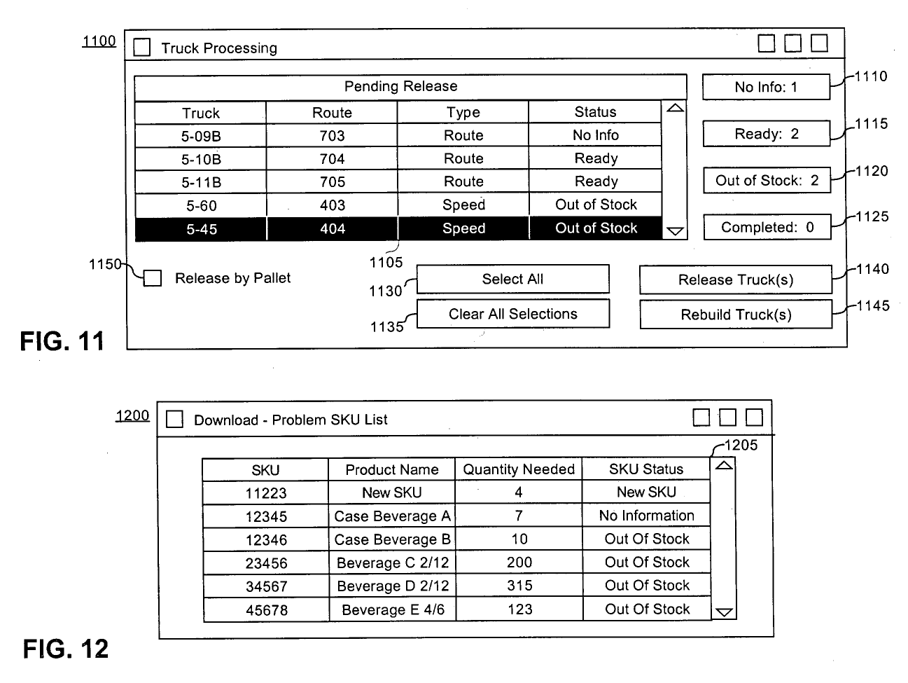

FIG. 11 is a schematic diagram illustrating an exemplary GUI 1100 which can be used for truck processing. The display field 1105 allows the operator to view the truck assignments and status for each truck and/or route. Additionally, the GUI 1100 includes data fields 1110, 1115, 1120, and 1125 representing various delivery vehicle status types used by the PRP system. As shown, the “No Info” status indicator indicates that one delivery vehicle cannot be built due to one or more cases of product lacking descriptive information in the PRP. The “Ready” status indicator 1110 indicates that 2 delivery vehicles can be built. The “Out of Stock” status indicator 1120 indicates that 2 delivery vehicles cannot be built due to one or more cases of product being out of stock. The “Competed” indicator 1125 indicates that there are no delivery vehicles completed, or no delivery vehicles which have been released for building.

According to one embodiment of the present invention, each entry displayed in the display field 1105 can be color coded according to delivery vehicle status. For example, each entry which has a “No Info” status can be similarly color coded. Each “Ready” status delivery vehicle can be similarly color coded. Accordingly, an operator can visually determine the status of various delivery vehicles. Notably, the icons 1110, 1115, 1120, and 1125 can be color coded to correspond with the entries listed in data field 1105. For example, the “Out of Stock” icon can be colored to match truck and/or delivery route entries in data field 1105.

The “Select All” icon 1130 can be used to select all trucks from the current truck list while the “Clear All Selections” icon 1135 can be used to clear all previously selected trucks from current truck list. The “Release Truck” icon 1140 can be used to release any selected trucks for building. Accordingly, the pallet configuration data for the selected trucks can be provided to the material handling machinery so that pallets conforming to the pallet configuration data can be built. The “Rebuild Truck” icon 1145 can be used to rebuild pallet configurations for trucks, for example where out of stock cases have been received or additional information has been input into the PRP to complete missing information for particular SKU numbers.

The “Release by Pallet” option 1150, if activated, allows cases to be released as specified by pallet configuration data for a single pallet. The option 1150 allows the automated material handling system to be tested using actual data and cases of product rather than predetermined test cases and/or pallets. Accordingly, using the “Release by Pallet” option 1150, the automated material handling system can be tested in a stepwise fashion, thereby facilitating the identification of any problematic components or segments within the system.

FIG. 12 is a schematic diagram illustrating an exemplary GUI 1200 for displaying problem SKU numbers and SKU number information. The GUI 1200 can be displayed responsive to user selection of one of the delivery trucks and/or delivery routes as shown in display field 1105 of FIG. 11, for example the highlighted delivery truck. In particular, the GUI 1200 can be used to display any SKU number that cannot be used to build a pallet. For instance, items which are out of stock or items that do not have sufficient information included in the PRP system can be displayed. Accordingly, as shown in FIG. 12, the GUI 1200 can include a display window 1205 which can list the problem SKU number, the product name corresponding to the SKU number, the quantity of the SKU number needed (for example for a release sequence), and the SKU number status. The SKU number status can indicate whether the particular SKU number is out of stock or not enough information has been entered in the PRP system.

The inventive arrangements disclosed herein provide an automated method, system, and apparatus for determining pallet configurations, building pallets, routing pallets to delivery vehicles, assigning pallets to delivery vehicle bays, and assigning delivery vehicles to delivery routes. The present invention can be realized in hardware, software, or a combination of hardware and software.

Aspects of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of providing cases of products to customers comprising:
identifying order attributes from received orders for cases;
identifying case attributes from inventory management data for cases specified in said orders;
associating cases with a pallet using said order attributes and said case attributes; and
for each case associated with said pallet, assigning said case a location within said pallet.

2. The method of claim 1, further comprising:
building said pallet using an automated material handling system according to said case-pallet associations and said assigned case locations.

3. The method of claim 1, wherein said order attributes are selected from the group consisting of a customer identifier, quantities of cases ordered, identities of cases ordered, and a delivery route identifier.

4. The method of claim 1, wherein said case attributes are selected from the group consisting of case dimensions, weights of cases, weight bearing capacity of cases, and quantities of cases available for fulfilling said orders.

5. The method of claim 1, wherein said case attributes specify case dimensions, said method further comprising:
identifying said case dimensions;
calculating a volume of said pallet as said cases are associated with said pallet according to said assigned cases and said case dimensions; and
discontinuing said associating step if said pallet volume exceeds a threshold volume.

6. The method of claim 5, further comprising:
using the automated material handling system, placing said cases on said pallet as specified by said case-pallet associations and said assigned case locations so as not to exceed said threshold volume.

7. The method of claim 1, wherein said case attributes specify case dimensions, said method further comprising:
identifying said case dimensions;
calculating a height of said pallet according to said case-pallet associations, said assigned case locations, and said case dimensions; and
discontinuing said associating step if said pallet height exceeds a threshold height.

8. The method of claim 7, further comprising:
using an automated material handling system, placing said cases on said pallet as specified by said case-pallet associations, said assigned case locations, and said case dimensions so as not to exceed said threshold height.

9. The method of claim 1, said assigning step comprising:
assigning said cases to particular locations within said pallet for delivery to customers in first-in-last-out fashion.

10. The method of claim 9, further comprising:
using an automated material handling system, placing said cases on said pallet in said particular locations for delivery to customers in first-in-last-out fashion.

11. The method of claim 1, further comprising:
performing said associating step and said assigning step for additional cases and additional pallets;
determining an order for loading said pallet and said additional pallets into a delivery vehicle in first-in-last-out fashion according to an ordering of customers on a delivery route.

12. The method of claim 1, wherein said case attributes specify weights of said cases, said assigning step further comprising:
identifying said weights of said cases for said pallet; and
assigning heavier ones of said cases to lower locations within said pallet than lighter ones of said cases.

13. The method of claim 12, further comprising:
using an automated material handling system, placing said heavier ones of said cases on said pallet in a lower location than said lighter ones of said cases.

14. The method of claim 1, wherein said case attributes specify weight bearing capacity of said cases, said assigning step further comprising:
identifying said weight bearing capacity of said cases for said pallet; and
assigning said cases with a greater weight bearing capacity to a lower location of said pallet than said cases having a smaller weight bearing capacity.

15. The method of claim 14, further comprising:
using an automated material handling system, placing said cases with a greater weight bearing capacity in a lower location of said pallet than said cases having a smaller weight bearing capacity.

16. The method of claim 1, further comprising:
accessing a customer profile of a customer for whom said pallet is being configured to determine whether bump cases can be received by said customer; and
said associating step further comprising associating bump cases with said pallet according to said customer profile.

17. The method of claim 1, further comprising:
providing, to an automated material handling system, pallet configuration data specifying an arrangement of cases for a single pallet, such that said automated material handling system builds said single pallet prior to releasing cases associated with a different pallet.

18. The method of claim 1, wherein cases are to be placed on said pallet by a single case placing system and a multiple case placing system, said method further comprising:
calculating a height of cases to be added to said pallet by said multiple case placing system; and
if said height exceeds a predetermined height, determining that said pallet is to be secured prior to adding additional cases with said single case placing system.

19. The method of claim 1, further comprising:
determining at least one delivery route for delivering cases to customers according to said order attributes, said case attributes, and known locations of said customers.

20. The method of claim 3, further comprising:
assigning said pallet to a delivery route according to said order attributes associated with said pallet.

21. The method of claim 20, further comprising:
assigning a delivery vehicle to a delivery route according order attributes, said case attributes, and at least one delivery vehicle attribute.

22. The method of claim 21, further comprising:
assigning a delivery vehicle to a delivery route according to delivery route attributes.

23. The method of claim 22, further comprising:
assigning said pallet to a bay of said delivery vehicle according to at least one delivery vehicle attribute.

24. The method of claim 4, wherein said case attributes specify quantities of cases available for fulfilling said orders, said method further comprising:
determining whether sufficient cases are available for fulfilling said orders.

25. The method of claim 24, further comprising:
if sufficient cases are not available, determining whether additional cases have become available for fulfilling said orders.

26. The method of claim 1, said assigning step further comprising:
assigning each said case a location in said pallet such that said pallet is comprised of full layers of cases of at least one case type and a top layer of cases of at least one case type which is less than a full layer.

27. The method of claim 1, wherein said order attributes specify cases for at least two different customers, said assigning step comprising:
assigning at least one case for each of said two different customers to a same layer in said pallet.

28. A method of providing cases of products to customers comprising:
determining an arrangement of cases for building a pallet using a pallet configuration processor with reference to identified case attributes and order attributes, wherein said arrangement of cases specifies a location for each case within said pallet;
storing cases in a case storage system;
releasing cases to a case transport system as specified by said arrangement of cases;
transporting said cases using said case transport system from said case storage system to a palletizing system as specified by said arrangement of cases; and
building at least one pallet using said palletizing system as specified by said arrangement of cases.

29. A method of providing cases of products to customers comprising:
retrieving inventory data specifying cases available for delivery to customers and case dimensions;
assigning a pallet to a delivery vehicle bay and identifying delivery vehicle bay dimensions;
determining an arrangement of cases forming at least one full layer of at least one case type for said pallet;
computing an available volume for adding a top layer of cases to said pallet according to said delivery vehicle bay dimensions and said case dimensions of cases within said at least one full layer; and
determining an arrangement of cases for a top layer for said pallet one case at a time such that a volume of said top layer does not exceed said available volume.

30. A method of providing cases of products to customers comprising:
retrieving inventory data specifying cases available for delivery to customers and case dimensions;
retrieving a plurality of orders, wherein each order specifies at least one case to be delivered to a customer and an associated delivery route;
associating each customer order with one of said delivery routes; and
assigning delivery vehicles to said delivery routes according to said cases to be delivered to customers on each said delivery route as determined from said orders and said case dimensions.

31. The method of claim 30, further comprising:
assigning said delivery vehicles to said delivery routes according to a delivery route type.

32. The method of claim 30, further comprising:
disassociating one of said customers from one of said delivery routes; and
associating said disassociated customer with a different one of said delivery routes.

33. A method of providing cases of products to customers comprising:
receiving an order specifying cases to be delivered to a customer;
receiving inventory data from an inventory management system;
processing said inventory data to determine whether sufficient inventory is available for fulfilling said customer order;
notifying a user that at least one of said ordered cases is unavailable; and
prompting the user whether to proceed despite the at least one unavailable case.

34. The method of claim 33, further comprising:
if said user response is to proceed, configuring at least one pallet without the at least one unavailable case.

35. A method of providing cases of products to customers comprising:
receiving at least one order specifying cases to be delivered to a customer;
receiving inventory data specifying case dimensions and weights of said cases; and
determining an arrangement of said cases to be delivered on a pallet, wherein heavier ones of said cases are assigned to locations lower in said pallet than lighter ones of said cases.

36. A method of providing cases of products to customers comprising:
receiving at least one order specifying cases to be delivered to a customer;
receiving inventory data specifying case dimensions and weight bearing capacity of said cases; and
determining an arrangement of said cases to be placed on a pallet, wherein cases capable of bearing more weight than other ones of said cases are assigned to lower locations within said pallet.

37. A system for organizing cases of products for delivery to customers comprising:
a pallet configuration processor configured to assign cases to locations within at least one pallet according to a type of cases ordered by customers, a number of cases ordered by customers, and dimensions of cases ordered by customers;
a case storage system configured to store said cases and release said cases according to said assigned locations of cases within said pallets;
a palletizing system configured to add selected ones of said cases to a pallet under construction according to said assigned case locations; and
a case transport system configured to deliver said cases from said case storage system to said palletizing system.

38. The system of claim 37, wherein said palletizing system is configured to build a top layer of cases for said pallet under construction, wherein said top layer of cases is less than a full layer of cases.

39. The system of claim 37, wherein said pallet configuration processor is configured to determine locations for cases within said pallets according to weights of individual cases ordered by customers.

40. The system of claim 37, wherein said pallet configuration processor is configured to assign heavier ones of said cases to lower locations in a pallet than lighter ones of said cases which are assigned to said pallet.

41. The system of claim 37, wherein said pallet configuration processor is configured to assign cases having a larger weight bearing capacity than other ones of said cases having a lesser weight bearing capacity to lower locations in said pallet.

42. The system of claim 37, wherein said pallet configuration processor is configured to calculate a volume of cases to be delivered on a delivery route and assign a delivery vehicle to said delivery route according to a type of said delivery route and said volume of cases to be delivered on said delivery route.

43. The system of claim 37, wherein said pallet configuration processor is configured to assign cases to said pallets according to delivery vehicle bay dimensions.

44. The system of claim 37, wherein said pallet configuration processor is communicatively linked to an inventory management system and a customer order entry system.

45. A machine-readable storage, having stored thereon a computer program having a plurality of code sections executable by a machine for causing the machine to perform the steps of:
identifying order attributes from received orders for cases;
identifying case attributes from inventory management data for cases specified in said orders;
associating cases with a pallet using said order attributes and said case attributes; and
for each case associated with said pallet, assigning said case a location within said pallet.

46. The machine-readable storage of claim 45, further comprising:
building said pallet using an automated material handling system according to said case-pallet associations and said assigned case locations.

47. The machine-readable storage of claim 45, wherein said order attributes are selected from the group consisting of a customer identifier, quantities of cases ordered, types of cases ordered, and a delivery route identifier.

48. The machine-readable storage of claim 45, wherein said case attributes are selected from the group consisting of case dimensions, weights of cases, weight bearing capacity of cases, and quantities of cases available for fulfilling said orders.

49. The machine-readable storage of claim 45, wherein said case attributes specify case dimensions, further comprising:
identifying said case dimensions;
calculating a volume of said pallet as said cases are associated with said pallet according to said assigned cases and said case dimensions; and
discontinuing said associating step if said pallet volume exceeds a threshold volume.

50. The machine-readable storage of claim 49, further comprising:
using the automated material handling system, placing said cases on said pallet as specified by said case-pallet associations and said assigned case locations so as not to exceed said threshold volume.

51. The machine-readable storage of claim 45, wherein said case attributes specify case dimensions, further comprising:
identifying said case dimensions;
calculating a height of said pallet according to said case-pallet associations, said assigned case locations, and said case dimensions; and
discontinuing said associating step if said pallet height exceeds a threshold height.

52. The machine-readable storage of claim 51, further comprising:
using an automated material handling system, placing said cases on said pallet as specified by said case-pallet associations, said assigned case locations, and said case dimensions so as not to exceed said threshold height.

53. The machine-readable storage of claim 45, said assigning step comprising:
assigning said cases to particular locations within said pallet for delivery to customers in first-in-last-out fashion.

54. The machine-readable storage of claim 53, further comprising:
using an automated material handling system, placing said cases on said pallet in said particular locations for delivery to customers in first-in-last-out fashion.

55. The machine-readable storage of claim 45, further comprising:
performing said associating step and said assigning step for additional cases and additional pallets;
determining an order for loading said pallet and said additional pallets into a delivery vehicle in first-in-last-out fashion according to an ordering of customers on a delivery route.

56. The machine-readable storage of claim 45, wherein said case attributes specify weights of said cases, said assigning step further comprising:
identifying said weights of said cases for said pallet; and
assigning heavier ones of said cases to lower locations within said pallet than lighter ones of said cases.

57. The machine-readable storage of claim 56, further comprising:
using an automated material handling system, placing said heavier ones of said cases on said pallet in a lower location than said lighter ones of said cases.

58. The machine-readable storage of claim 45, wherein said case attributes specify weight bearing capacity of said cases, said assigning step further comprising:
identifying said weight bearing capacity of said cases for said pallet; and
assigning said cases with a greater weight bearing capacity to a lower location of said pallet than said cases having a smaller weight bearing capacity.

59. The machine-readable storage of claim 58, further comprising:
using an automated material handling system, placing said cases with a greater weight bearing capacity in a lower location of said pallet than said cases having a smaller weight bearing capacity.

60. The machine-readable storage of claim 45, further comprising:
accessing a customer profile of a customer for whom said pallet is being configured to determine whether bump cases can be received by said customer; and
said associating step further comprising associating bump cases with said pallet according to said customer profile.

61. The machine-readable storage of claim 45, further comprising:
providing, to an automated material handling system, pallet configuration data specifying an arrangement of cases for a single pallet, such that said automated material handling system builds said single pallet prior to releasing cases associated with a different pallet.

62. The machine-readable storage of claim 45, wherein cases are to be placed on said pallet by a single case placing system and a multiple case placing system, further comprising:
calculating a height of cases to be added to said pallet by said multiple case placing system; and
if said height exceeds a predetermined height, determining that said pallet is to be secured prior to adding additional cases with said single case placing system.

63. The machine-readable storage of claim 45, further comprising:
determining at least one delivery route for delivering cases to customers according to said order attributes, said case attributes, and known locations of said customers.

64. The machine-readable storage of claim 47, further comprising:
assigning said pallet to a delivery route according to said order attributes associated with said pallet.

65. The machine-readable storage of claim 64, further comprising:
assigning a delivery vehicle to a delivery route according order attributes, said case attributes, and at least one delivery vehicle attribute.

66. The machine-readable storage of claim 65, further comprising:
assigning a delivery vehicle to a delivery route according to delivery route attributes.

67. The machine-readable storage of claim 66, further comprising:
assigning said pallet to a bay of said delivery vehicle according to at least one delivery vehicle attribute.

68. The machine-readable storage of claim 48, wherein said case attributes specify quantities of cases available for fulfilling said orders, said machine-readable storage causing said machine to perform the further step of:
determining whether sufficient cases are available for fulfilling said orders.

69. The machine-readable storage of claim 68, further comprising:
if sufficient cases are not available, determining whether additional cases have become available for fulfilling said orders.

70. The machine-readable storage of claim 45, said assigning step further comprising:
assigning each said case a location in said pallet such that said pallet is comprised of full layers of cases of at least one case type and a top layer of cases of at least one case type which is less than a full layer.

71. The machine-readable storage of claim 45, wherein said order attributes specify cases for at least two different customers, said machine-readable storage causing said machine to perform the further step of:
assigning at least one case for each of said two different customers to a same layer in said pallet.

72. A machine-readable storage, having stored thereon a computer program having a plurality of code sections executable by a machine for causing the machine to perform the steps of:
determining an arrangement of cases for building a pallet using a pallet configuration processor with reference to identified case attributes and order attributes, wherein said arrangement of cases specifies a location of each case within said pallet;
storing cases in a case storage system;
releasing cases to a case transport system as specified by said arrangement of cases;
transporting said cases using said case transport system from said case storage system to a palletizing system as specified by said arrangement of cases; and
building at least one pallet using said palletizing system as specified by said arrangement of cases.

73. A machine-readable storage, having stored thereon a computer program having a plurality of code sections executable by a machine for causing the machine to perform the steps of:
retrieving inventory data specifying cases available for delivery to customers and case dimensions;
assigning a pallet to a delivery vehicle bay and identifying delivery vehicle bay dimensions;
determining an arrangement of cases forming at least one full layer of at least one case type for said pallet;
computing an available volume for adding a top layer of cases to said pallet according to said delivery vehicle bay dimensions and said case dimensions of cases within said at least one full layer; and
determining an arrangement of cases for a top layer for said pallet one case at a time such that a volume of said top layer does not exceed said available volume.

74. A machine-readable storage, having stored thereon a computer program having a plurality of code sections executable by a machine for causing the machine to perform the steps of:
retrieving inventory data specifying cases available for delivery to customers and case dimensions;
retrieving a plurality of orders, wherein each order specifies at least one case to be delivered to a customer and an associated delivery route;
associating each customer order with one of said delivery routes; and
assigning delivery vehicles to said delivery routes according to said cases to be delivered to customers on each said delivery route as determined from said orders and said case dimensions.

75. The machine-readable storage of claim 74, further comprising:
assigning said delivery vehicles to said delivery routes according to a delivery route type.

76. The machine-readable storage of claim 74, further comprising:
disassociating one of said customers from one of said delivery routes; and
associating said disassociated customer with a different one of said delivery routes.

77. A machine-readable storage, having stored thereon a computer program having a plurality of code sections executable by a machine for causing the machine to perform the steps of:
receiving an order specifying cases to be delivered to a customer;
receiving inventory data from an inventory management system;
processing said inventory data to determine whether sufficient inventory is available for fulfilling said customer order;
notifying a user that at least one of said ordered cases is unavailable; and
prompting the user whether to proceed despite the at least one unavailable case.

78. The machine-readable storage of claim 77, further comprising:
if said user response is to proceed, configuring at least one pallet without the at least one unavailable case.

79. A machine-readable storage, having stored thereon a computer program having a plurality of code sections executable by a machine for causing the machine to perform the steps of:
receiving at least one order specifying cases to be delivered to a customer;
receiving inventory data specifying case dimensions and weights of said cases; and
determining an arrangement of said cases to be delivered on a pallet, wherein heavier ones of said cases are assigned to locations lower in said pallet than lighter ones of said cases.

80. A machine-readable storage, having stored thereon a computer program having a plurality of code sections executable by a machine for causing the machine to perform the steps of:
receiving at least one order specifying cases to be delivered to a customer;
receiving inventory data specifying case dimensions and weight bearing capacity of said cases; and
determining an arrangement of said cases to be placed on a pallet, wherein cases capable of bearing more weight than other ones of said cases are assigned to lower locations within said pallet.
